(19) United States
(12) Patent Application Publication
(10) Pub. No.: US 2010/0319683 A1
(43) Pub. Date: Dec. 23, 2010

(54) Molded Securing Device for an Optical Element

(75) Inventors: Stephen J. Senatore, South San Francisco, CA (US); Peter Young, San Francisco, CA (US)

Correspondence Address: THE MUELLER LAW OFFICE, P.C., 12951 Harwick Lane, San Diego, CA, 92130, US

(73) Assignee: SOLFOCUS, INC., Mountain View, CA (US)

(21) Appl. No.: 12/488,492

(22) Filed: Jun. 19, 2009

(51) Int. Cl. F24J 2/46; B23P 11/00

(52) U.S. Cl. 126/704; 29/428

(57) ABSTRACT

The present invention is directed to a device and method for securing optical elements in a solar energy system. Molded securing devices are fixed directly to the front panel of a solar energy system to provide for secure, aligned placement of optical components. In some embodiments, the peripheral edge of a front panel may be encapsulated by the molded device to provide alignment of peripheral optical elements and a secure water resistant seal between the front panel and a backpan. In other embodiments, molded securing devices may be positioned away from the peripheral edge to assist in alignment of central optical elements.

### BACKGROUND OF THE INVENTION

It is generally appreciated that one of the many known technologies for generating electrical power involves the harvesting of solar radiation and its conversion into direct current (DC) electricity. Solar power generation has already proven to be a very effective and “environmentally friendly” energy option, and further advances related to this technology continue to increase the appeal of such power generation systems. In addition to achieving a design that is efficient in both performance and size, it is also desirable to provide power units and corresponding solar systems that are characterized by reduced cost and increased levels of mechanical robustness.

Solar concentrators are solar energy generators which increase the efficiency of conversion of solar energy to DC electricity. Solar concentrators which are known in the art utilize parabolic mirrors and Fresnel lenses for focusing the incoming solar energy, and heliostats for tracking the sun's movements in order to maximize light exposure. A new type of solar concentrator, disclosed in U.S. Patent Publication No. 2006/0266408, entitled, “Concentrator Solar Photovoltaic Array with Compact Tailored Imaging Power Units” utilizes a front panel for allowing solar energy to enter the assembly, with a primary mirror and a secondary mirror to reflect and focus solar energy onto a solar cell. A back pan encloses the assembly and provides structural integrity. The surface area of the solar cell in such a system is much smaller than what is required for non-concentrating systems, for example less than 1% of the entry window surface area. Such a system has a high efficiency in converting solar energy to electricity due to the focused intensity of sunlight, and also reduces cost due to the decreased amount of costly photovoltaic cells required. Because the receiving area of the solar cell is small relative to that of the power unit, the ability of the mirrors to accurately focus the sun's rays onto the solar cell is important to achieving the desired efficiency of such a solar concentrating system.

In this type of solar concentrator, one of the important factors in manufacture is the mechanism and process by which a mirror is aligned and secured in the x-y plane and vertically along the z-axis of the front panel. Thus, it is desirable to facilitate reliable alignment of mirrors in a solar concentrator in the x-y plane of a concentrator panel in a manner that facilitates manufacturability and improves mechanical robustness. In addition, the choice of materials for attaching an optical element to a front panel is limited due to the extended specifications for this joint (e.g., flexibility, low creep). It is also desirable to have a mounting system that is stable and resists degradation over prolonged exposure to sunlight. Such design requirements are usually incompatible with a fast cure material and leads to long curing time prior to moving the system. A method to reduce the time for securing the optical component is very desirable in order to increase the production throughput.

### SUMMARY OF THE INVENTION

The present invention is a system for securing and aligning a front panel and optical elements in an array of concentrated solar energy devices, where the optical elements concentrate solar energy. In one embodiment, securing devices are molded onto a front panel in predetermined locations to achieve a desired alignment of the optical components. The securing devices may facilitate the attachment of the optical components. The molded securing devices of this invention may be fixed to the back portion of a front panel of a solar energy device, and may include the use of ceramic frit in some embodiments.

### BRIEF DESCRIPTION OF THE DRAWINGS

FIG. 1 depicts solar concentration panels in accordance with exemplary panels known in the art;

FIG. 2 depicts a cross-section of a solar concentrating power unit in accordance with the prior art;

FIGS. 3A-C depict embodiments of primary and secondary mirrors as known in the prior art;

FIG. 4 depicts a cross-section of a solar panel in accordance with an embodiment of the present invention;

FIG. 5A depicts a perspective view of a portion of a solar panel in accordance with an embodiment of the present invention; FIG. 5B depicts a perspective view of an embodiment of a molded securing device of this invention;

FIGS. 6A-B depict a cutaway view of two embodiments of a molded securing device used to secure an optical component to the front panel of a solar concentrating panel in accordance with the present invention;

FIG. 7A depicts an embodiment of a molded securing device used to secure a secondary mirror to the front panel of a solar concentrating panel in accordance with the present invention; FIGS. 7B-C depict two cross sectional views of an embodiment of a molded securing device used to secure a primary mirror to the front panel of a solar concentrating panel in accordance with the present invention;

FIG. 8 illustrates an exemplary method for manufacturing a molded securing device of this invention.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not a limitation of the present technology. It will be apparent to those skilled in the art that modifications and variations can be made in the present technology without departing from the spirit and scope thereof. For instance, features illustrated or described as part of one embodiment may be used on another embodiment to yield a still further embodiment. Thus, it is intended that the present subject matter covers such modifications and variations as come within the scope of the appended claims and their equivalents.

The alignment processes and mechanisms described in this disclosure are based on a solar power concentrator design incorporating optically aligned primary and secondary mirrors. The solar power concentrator design is described with further detail in U.S. Patent Publication No. 2006/0266408 entitled, “Concentrator Solar Photovoltaic Array with Compact Tailored Imaging Power Units,” filed May 26, 2005; and U.S Patent Publication No. 2006/0274439 entitled, “Optical System Using Tailored Imaging Designs,” filed Feb. 9, 2006, which claims priority from U.S. Provisional Patent Application No. 60/651,856 filed Feb. 10, 2005. Both of these applications are hereby incorporated herein by reference in their entirety for all purposes. However, it should be appreciated that the invention of this disclosure is not limited to these configurations and may be applied to other solar concentrator designs as well.

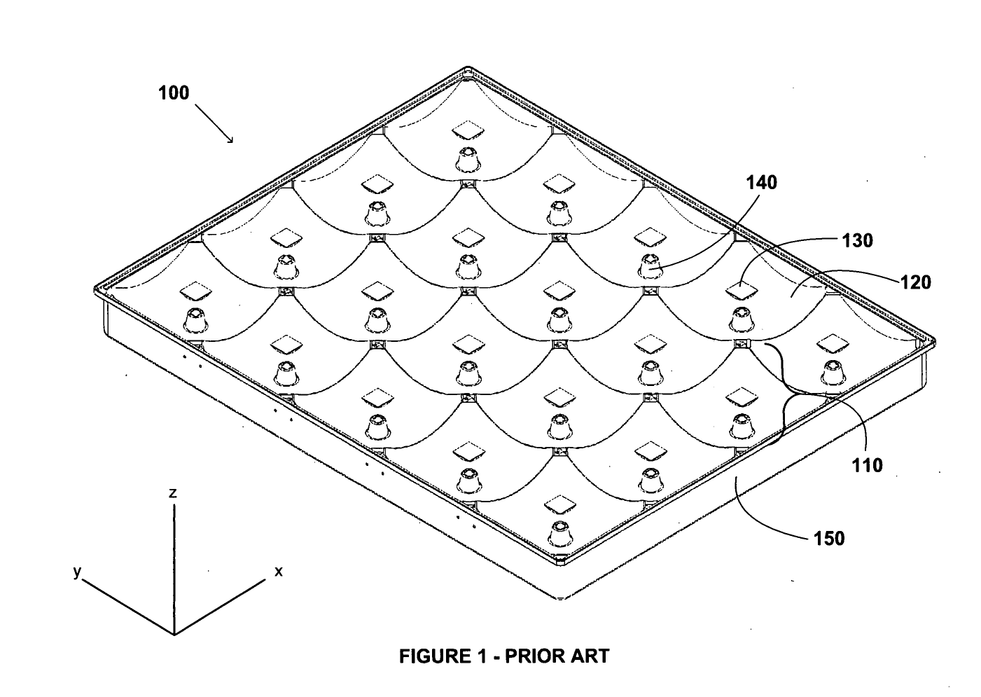

FIG. 1 depicts a solar power generating system comprising a solar panel 100 provided in a substantially planar configuration for concentrating solar energy onto photovoltaic cells (not shown) that convert solar energy into direct current electricity. The example depicted in FIG. 1 shows a single solar panel 100, but it should be appreciated that any number of solar panels may be employed, from a single solar panel to many more than four panels. Each solar panel 100 houses an array of solar concentrating power units 110 that concentrate solar radiation using a primary mirror 120 and a secondary mirror 130 to an optical rod (not shown) in a receiving assembly 140 that conducts the solar energy to the photovoltaic cell (not shown). In the exemplary illustration of FIG. 1, twenty power units 110 are shown arranged in a backpan 150, although any number of power units 110 may be used. Such power units may be provided in a variety of configurations, some of which will be discussed in further detail below.

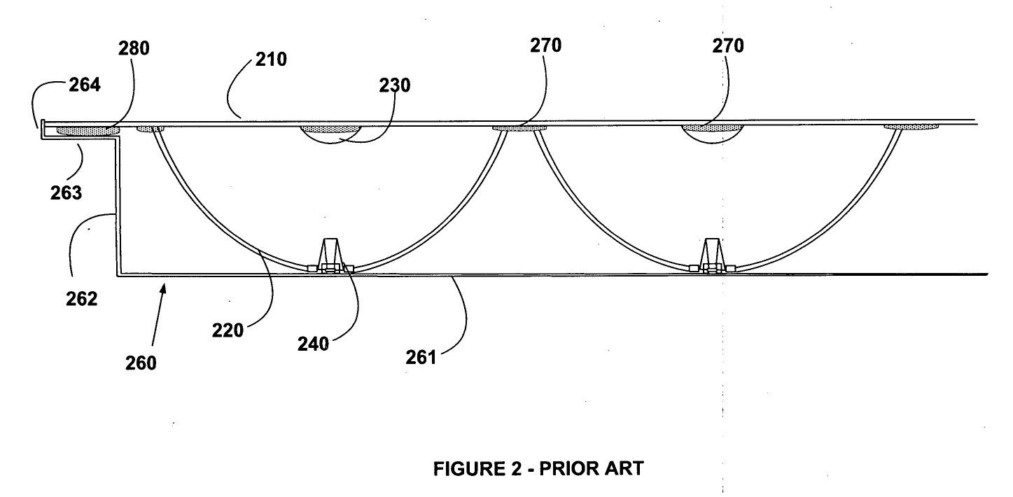

Referring to FIG. 2, a cross section of select exemplary optical components of each power unit will now be described as an example of the prior art. The main optical elements of each power unit are the primary mirror 220, secondary mirror 230, and receiver assembly 240. One or more power units are housed in an assembly that includes a front panel 210 and a back pan 260 comprised of a back portion 261 and side portion 262. The back pan may also include an edge 263 and lip feature 264 to provide, among other things, structural stability to the solar panel. In the preferred embodiment, the shapes of primary mirror 220 and secondary mirror 230 are tailored to capture maximum solar radiation. Receiver assembly 240 transmits the concentrated solar energy to a photovoltaic cell (not shown). Front panel 210 is a sheet of material forming a substantially planar surface, such as a window or other glazed covering that may provide structural integrity for an array of power units and protection for other components thereof. The back pan 260 provides structural integrity and environmental protection for the power units. Primary mirror 220 and secondary mirror 230 are both illustrated as curved components, although it should be appreciated that other shapes may be used. It will also be appreciated that lenses may be used in place of mirrors or the front panel for concentrating the solar energy. In one embodiment, primary mirror 220 is slump-formed from soda-lime glass. In another embodiment the secondary mirror 230 may be formed from a solid piece of borosilicate glass. The portions of primary mirror 220 and secondary mirror 230 that are connected to the front panel 210 shown in FIG. 2 are physically attached thereto by adhesive bonding 270. The front panel 210 is secured to the back pan 260 to form a weather tight seal. The front panel 210 is attached to back pan 260 by means of an adhesive tape 280 such as VHB™ tape.

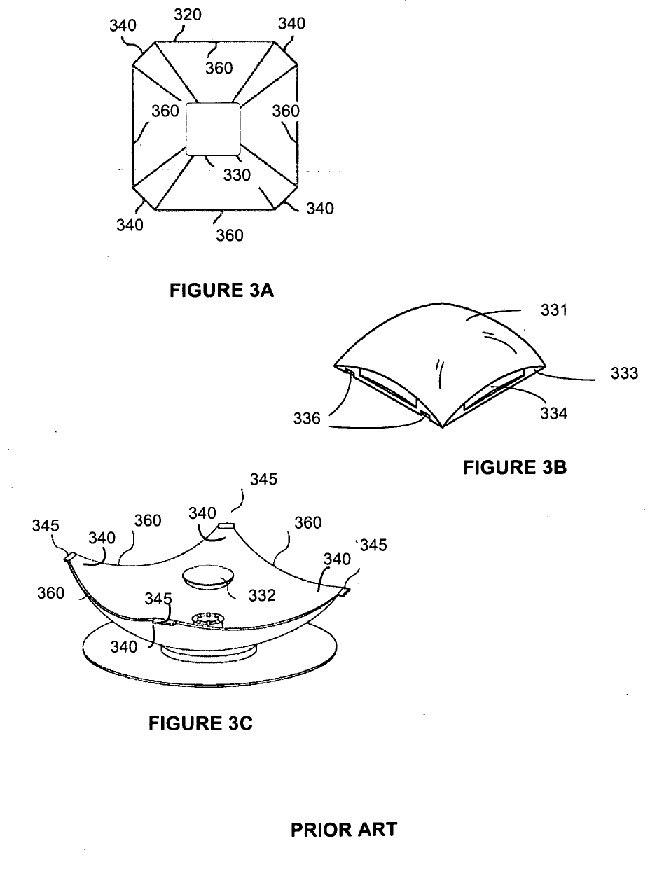

Referring now to FIGS. 3A-3C, the perimeter of each primary mirror 320 may be formed in a variety of different fashions as understood in the prior art. In one embodiment shown in FIG. 3A, the primary mirror 320 is formed in an approximate square configuration. The perimeter of primary mirror 320 may be defined by four full sections 340, and four truncated sections 360. Full sections 340 are substantially coplanar with one another such that they may be provided in contact with substantially parallel with and/or connected to the surface of front panel 210 (FIG. 2). The full sections may optionally include mounting tabs 345 located at the ends of the full sections 440. Each truncated section 360 of the perimeter of primary mirror 320 is formed to define a generally arched segment that extends away from front panel 210. Each truncated section 360 exists in a respective vertical plane that is substantially perpendicular to front panel 210. Truncated sections 360 of each primary mirror 320 may be matched against a truncated section of an adjacent power unit's primary mirror. An array of power units may comprise substantially square perimeter primary mirrors 320 along with secondary mirrors 330. Each truncated side 360 of the perimeter of primary mirror 320 is formed to define a generally arched segment.

The perimeter of each secondary mirror 330 may likewise be formed in a variety of different fashions such as square 331 (FIG. 3B) or circular 332 (FIG. 3C). The perimeter of secondary mirror 331 may be defined by four truncated sides 333. Each side may optionally include positional indentations 336 or optional datum features 334 to facilitate alignment and manufacturing of the solar concentrating unit. The secondary mirror 331 has been described in co-pending U.S. patent application Ser. No. 12/021,238 “Solar Concentrator with Square Mirrors” which is incorporated by reference herein.

It should be appreciated in some embodiments of this disclosure that the respective perimeters (or portions thereof) of the primary and secondary mirrors may not be precisely arranged in a coplanar fashion. Effective operation of a power unit may still be achieved with a slightly staggered arrangement along the coaxial alignment of primary and secondary mirrors within a predetermined tolerance. It will be further appreciated that although FIGS. 3A-3C depict exemplary embodiments for the shape of primary and secondary mirrors, many other options may be employed in accordance with the present invention. For example, the perimeter of primary mirror 320 may be formed as any near-polygonal shape defined by n full sections and n truncated sections, where n is an integer number generally within a range of between three and nine. Each of the full sections in such embodiments may be fixed to the inner surface of a front panel via the molded securing device of this invention. Each truncated section is formed as a circular arc that extends away from the front window and that exists in a respective plane that is substantially perpendicular to the front window.

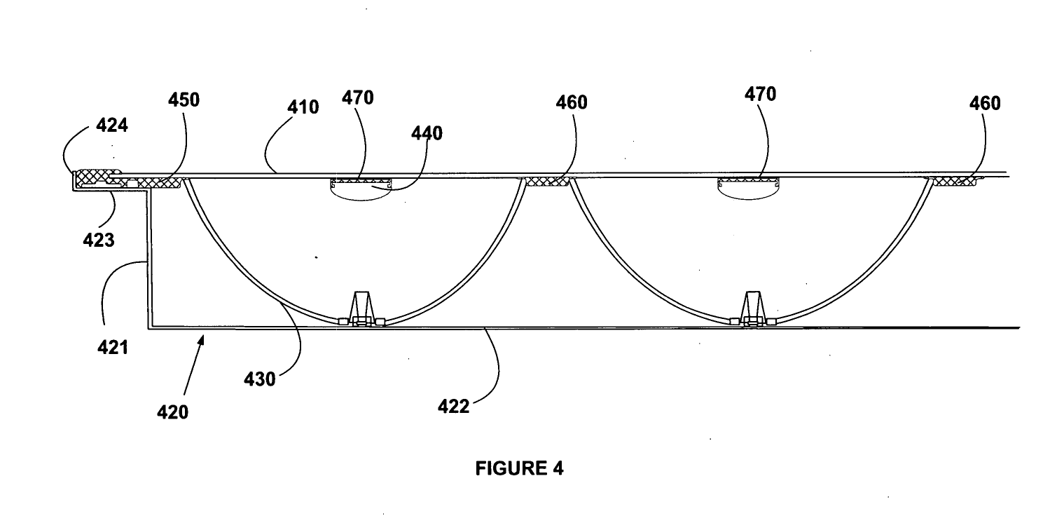

FIG. 4 depicts a cross-section of a solar panel in accordance with an embodiment of the present invention. This solar panel comprises, generally and without limitation, a front panel 410, a back pan 420, primary mirrors 430, secondary mirrors 440, a peripheral molded securing device 450, primary mirror securing devices 460, and secondary mirror securing devices 470. In one embodiment, the front panel may be glass or plastic or any transparent material. As noted, FIG. 4 excludes many items, such as wiring and solar cells, in order to focus on structural elements of the solar panel. In one embodiment of this invention the back pan 420 may include side portions 421, a bottom portion 422, as well as an edge 423 and lip feature 424 to provide, among other things, structural stability to the solar panel. The bottom portion 422 of the back pan 420 may be coffered or flat or any other shape. The molded securing devices 450, 460, 470 of this invention beneficially locate and fix the position of optical elements in a solar energy system. The molded securing devices may be fixed directly onto the front panel 410, in any predetermined location on the x-y plane of front panel 410 such that a desired alignment of the optical elements will be achieved, within certain tolerances. The molded securing devices of this invention 450, 460, 470 are molded to the bottom side of the front panel 410 and may or may not contact the bottom portion 422 of the back pan 420. When not contacting the bottom portion 422, this may advantageously provide positional stability for the optical elements 430 and 440 in the event of damage or vibrations in the back pan. In one embodiment the areas of front panel 410 onto which the molded securing devices 450, 460, 470 will be fixed may be abraded or frosted prior to molding. The front panel may be abraded by any mechanical means. In one embodiment, predetermined areas of the front panel may be chemically etched or frosted. This may beneficially lead to increased adherence of the molded securing devices. In an alternative embodiment, a layer of ceramic frit may be disposed between one or more of the molded securing devices 450, 460, 470 and the front panel 410 to beneficially improve the adherence. One aspect of this invention is the reduced use of adhesive for fixing optical elements to the solar energy device, advantageously improving the reliability of the solar energy device. Adhesives such as glue or adhesive tape may degrade under prolonged exposure to solar radiation such as that experienced by a solar energy device.

The molded securing device of this invention may have a durometer value that provides stiffness sufficient to hold the optical elements while providing flexibility for cushioning potentially damaging vibrations that may be experienced by the solar energy device during manufacture, installation or use. In one embodiment the molded securing device may have a durometer value that provides for flexibly mounting rigid optical elements into a desired position while retaining a stiffness to fix the optical elements in a predetermined position. For instance, the molded optical elements of this invention may have a durometer value of between 20 and 80 Shore A. In a particular embodiment the molded securing device of this invention may have a durometer value between 40 and 60 Shore A.

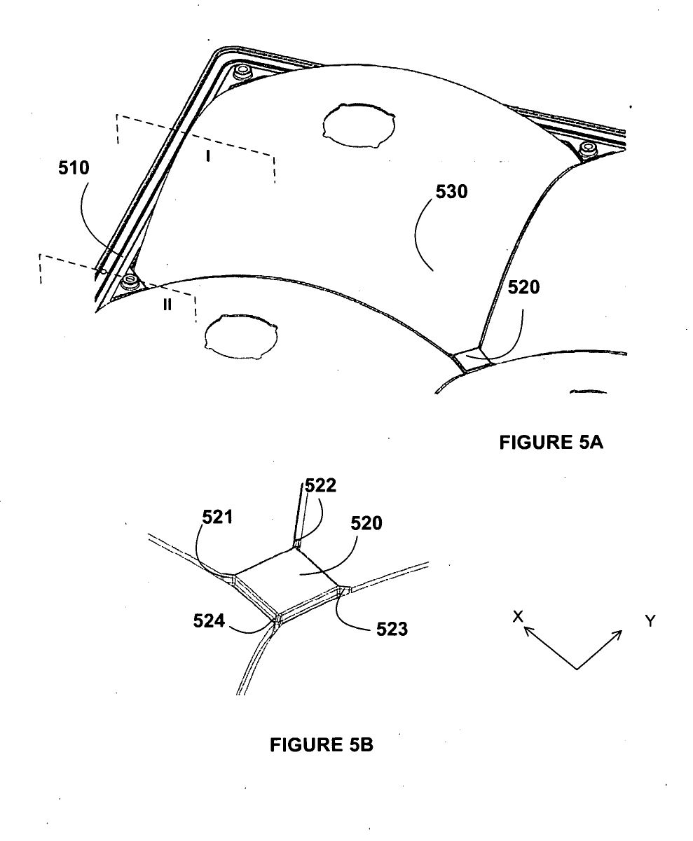

One aspect of the current invention is facilitating the alignment of primary 430 and secondary mirrors 440 in the x-y plane of front panel 410 in an array of primary mirrors to form an array of power units within a solar panel. The skilled artisan will appreciate that facilitating proper alignment of the primary mirrors, within a certain tolerance, will facilitate the manufacturability of the arrays and hence the solar concentrating system. FIG. 5A depicts a perspective view of select elements of a solar energy device in order to illustrate the precise positioning of the primary mirror by the molded securing device of this invention. In one embodiment of this invention the peripheral 510 and central 520 securing devices may fix the primary mirror 530 in the x-y plane of front panel. The peripheral 510 securing devices may additionally locate and fix the front panel to the edges of the back pan. The molded securing devices of the present invention are described herein with reference to aligning and securing of optical components in a solar energy system. It will be appreciated that this and other embodiments of the present invention are not limited to one particular shape of the optical components.

FIG. 5A shows a perspective drawing of one embodiment of this invention viewed from inverted primary mirrors 530 mounted to the front panel (not shown). The peripheral edge of the front panel is encapsulated in a molded securing device 510. The securing devices 510 and 520 may be molded onto the front panel with precision sufficient to provide accurate alignment of the primary mirrors. The molded securing devices may be molded to any predetermined location on the front panel to facilitate this alignment. In one embodiment, the molded securing device may encapsulate the peripheral edge of the front panel. This may provide alignment and securing features for the primary mirror 530. This embodiment may also provide an advantageously weather tight seal between the front panel and the back pan. In one embodiment, the molded securing device of this invention may align optical elements on the x-y plane of the front panel with a precision on the order of 0.4 mm or less, for example 0.1 mm. For the purpose of discussion, and not by way of limitation, a primary mirror molded securing device may secure four adjacent primary mirrors. FIG. 5B depicts a closer perspective view of one embodiment of the primary mirror securing device 520 where four features (521-524) in the molded device are shown that may orient the mirrors in the x-y plane. Features 521-524 may be, for example, tabs, grooves, apertures, indentations, datum or any geometry known in the art for positioning a component.

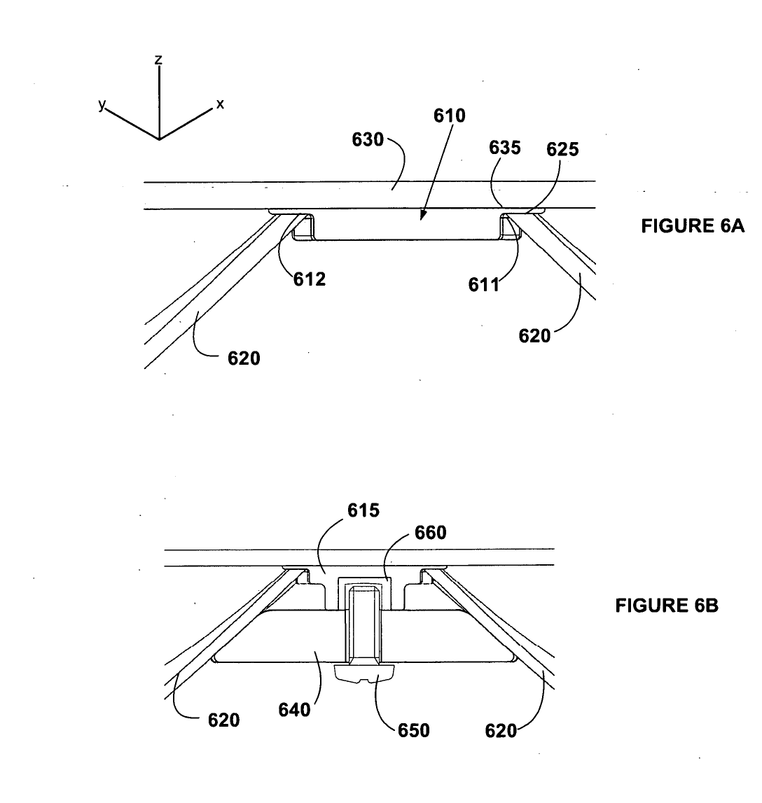

FIG. 6A depicts a cutaway view of an embodiment of a molded securing device 610 of this invention that may orient the primary mirrors 620 on the x-y plane of the front panel 630. The molded securing device 610 may also direct the placement of the primary mirrors 620 along the z axis by providing a boundary along the z axis via the thickness of feature 612 and 611 that defines the distance between the bottom 635 of the front panel 630 and the top 625 of the primary mirror 620. Features 611 and 612 function to position and orient the primary mirrors 620 relative to the front panel 630, and may incorporate features such as notches, grooves, apertures, indentations, datum or any geometry known in the art for positioning a component. FIG. 6B shows an embodiment of this invention that includes an optional retaining element 640 attached to the securing device 615 by means of a screw 650 or other fastening device connected to an insert 660 molded into the securing device 615. In one embodiment, the securing device 615 may be configured to receive a retaining element. In a particular embodiment the molded securing device may include an insert 660 for receiving a connecting device such as a screw, bolt, rivet or the like. In an alternative embodiment, a screw or other connecting device may be embedded into the molded securing device (not shown). The retaining element 640 may provide additional support to the primary mirrors 620 in a position defined by the molded securing device 615. This may beneficially improve the reliability of the solar energy device as optical elements are secured in a defined position and remain reliably aligned over the lifetime of the solar energy system.

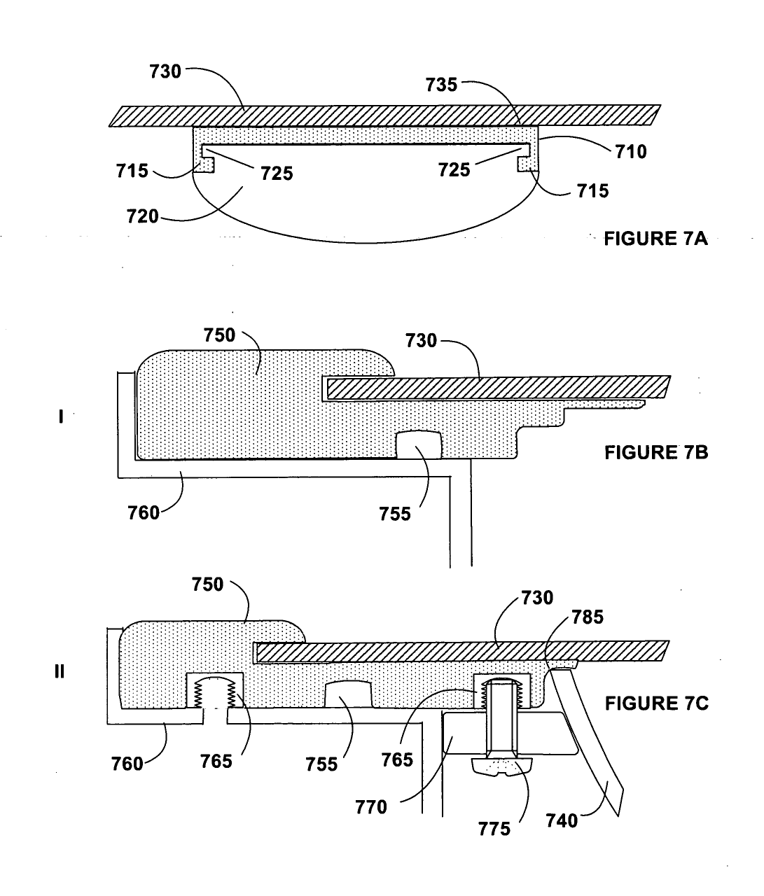

The molded securing device of this invention may secure any optical element in a solar energy device. In one embodiment shown in FIG. 7A, a securing device 710 may secure a secondary mirror 720 to a front panel 730. In one particular embodiment, the securing device 710 may include features 715 to align and interlock with indentations 725 in the secondary mirror 720. The features may 715 interlock on one or more of the sides of the secondary mirror 720. The features 715 may be in the form of apertures, indentations, notches or any shape that may interlock or position the secondary mirror. The features 715 may serve to fixedly hold the secondary mirror without the need for adhesives, or may be used in conjunction with adhesives. The positional features may also define and orient the secondary mirror in the z direction by defining and fixing the distance between the secondary mirror and the bottom 735 of the front panel.

The portions of an optical element 740 located on the peripheral edge of a solar energy device may be positioned and fixed by a molded securing device 750 of this invention. One embodiment of this invention is illustrated in FIGS. 7B and 7C where two cross sections from regions of the solar energy device shown in FIG. 5 indicated along axis I and II are shown. One feature shown in FIG. 7B, is that the molded securing device 750 may encapsulate the peripheral edge of the front panel 730 and beneficially form a seal between the front panel 730 and the back pan 760 of a solar energy device. The molded securing device 750 may surround the peripheral edge of the front panel 730 with sufficient tightness that an adhesive material between the front panel and the securing device is not needed. In another embodiment the molded securing device 750 may contain cavities 755 for the deposition of adhesives or other material to improve the weather resistance of the front panel to back pan seal. In still another embodiment shown in FIG. 7C, the molded securing device 750 may include an embedded insert 765 in which to secure a connecting element 775 (e.g., screw, bolt, rivet, etc.) to connect the molded securing device 750 to the back pan 760 or to a retaining element 770. The molded securing device 750 may include alignment features 785, such as a lip, groove, or the like, to direct the position of an optical element 740. The molded securing device of this invention may provide positional fixing for optical elements relative to the peripheral edge of the front panel. This may beneficially improve the precision of the alignment of the optical elements as well as provide addition protection from vibrations or damage. Another aspect of this invention is the improved manufacturability of a weather tight seal between the front panel and the back pan.

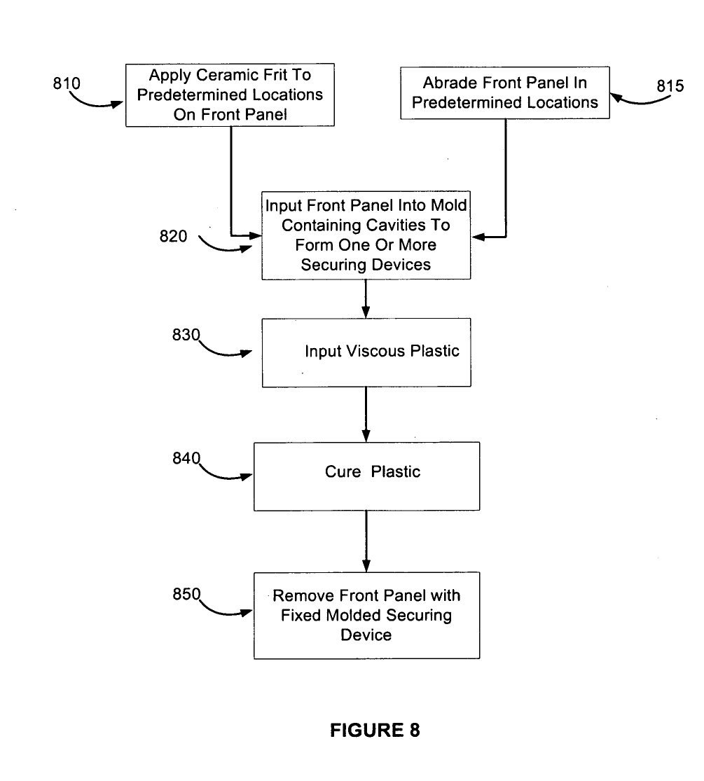

The molded securing device of this invention may be manufactured any method, for example injection molding. The molded securing device of this invention may be fixed to the front panel by any means. In one embodiment illustrated in FIG. 8, a ceramic frit may be deposited in predetermined locations on the front panel in step 810. The ceramic frit may be applied by dipping, spraying, painting, screen printing, extrusion, digital transfer or any other method known in the art. The ceramic frit may be cured by heat, chemical or any other treatment known in the art for curing a ceramic frit. In an alternative embodiment the front panel may be mechanically abraded or chemically etched to present a region of high surface area in predetermined locations and the securing device may be molded directly to those regions in step 815. The front panel may then be placed into a mold that includes the cavities to form one or more securing devices in step 820. The material for the molded securing device may be a plastic material such as a thermoplastic polymer or blend of polymers (e.g., unsaturated polyester, a polyamide, non-elastomeric polyurethane, polyacetal, or the like). Once in the mold, the plastic may be deposited into the cavities in a viscous form in step 830. The plastic may be cured and hardened either by cooling or chemical means in step 840. The method of this invention may also include more complex methods of manufacture such as gas-assisted injection molding. Once removed from the mold in step 850, the front panel and affixed securing devices are ready for assembly into a solar energy device.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed:

1. A system for positioning optical elements in a solar energy system comprising:
a sheet of material having a top side, a bottom side, and a peripheral edge;
a back pan have side portions and a bottom portion, wherein the back pan is coupled to the peripheral edge of the sheet; and
one or more molded securing device fixed to predetermined positions on the bottom side of the sheet of material, wherein the molded securing device comprises an alignment feature for an optical element and wherein the molded securing device is not in contact with the bottom portion of the back pan.

2. The system of claim 1, further comprising ceramic frit disposed between the molded securing device and the sheet of material.

3. The system of claim 1, wherein the sheet of material is transparent.

4. The system of claim 1, wherein the sheet of material is glass.

5. The system of claim 1, wherein the molded securing device encapsulates the peripheral edge of the sheet of material.

6. The system of claim 1, wherein the molded securing device comprises a thermoplastic material.

7. The system of claim 1, wherein the alignment feature determines the x, y, and z positional alignment of the optical element.

8. The system of claim 1, wherein the alignment feature is a selected from the group consisting of tabs, grooves, apertures, indentations and datum.

9. The system of claim 1, wherein the molded securing device has a durometer between 20-80 Shore A.

10. The system of claim 1, wherein the molded securing device further comprises a retaining element.

11. The system of claim 1, wherein the molded securing device is configured to receive a fastener.

12. The system of claim 1, wherein the molded securing device comprises a threaded insert.

13. The system of claim 1, wherein the molded securing device is located away from the peripheral edge.

14. A solar energy device comprising:
a transparent sheet of material having a top side, a bottom side, and a peripheral edge;
a back pan have side portions and a bottom portion, wherein the back pan is coupled to the peripheral edge of the transparent sheet; and
one or more molded securing device fixed to predetermined positions on the bottom side of the sheet of material, wherein the molded securing device comprises an alignment feature for an optical element.

15. The solar energy device of claim 14, wherein the optical element is one of a primary mirror and a secondary mirror.

16. A method of positioning optical components of a solar energy system comprising:
providing a front panel having a top side, a bottom side, and a peripheral edge;
providing a back pan having sides and a bottom; and
attaching one or more molded securing devices to predetermined positions on the bottom side of the front panel, wherein the securing devices comprise alignment features for an optical component.

17. The method of claim 16, further comprising encapsulating the peripheral edge of the front panel with the securing device.

18. The method of claim 16, wherein the step of attaching comprises applying a layer of ceramic frit.

19. The method of claim 16, further comprising aligning the optical component in three dimensions relative to the molded securing devices.

20. The method of claim 16, wherein the molded securing devices have a durometer between 20-80 Shore A.

21. A method of manufacturing molded securing devices onto a front panel comprising:
placing a front panel into a mold comprising cavities in predetermined locations;
inputting a viscous thermoplastic into the cavities of the mold to form molded securing devices, wherein the molded securing devices comprise an alignment feature for an optical element; and
curing the thermoplastic.

22. The method of claim 21, further comprising applying ceramic frit to the front panel in areas corresponding to the predetermined locations of the cavities.

23. The method of claim 21, wherein the optical element is a mirror for a solar energy device.
